(19) United States
(12) Patent Application Publication
(10) Pub. No.: US 2009/0292923 A1
(43) Pub. Date: Nov. 26, 2009

(54) KEY-IN PROCESSING DEVICE AND METHOD

(75) Inventors: Masayuki Kurisu, Kawasaki (JP); Kazuhiro Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/421,906

(22) Filed: Apr. 10, 2009

(30) Foreign Application Priority Data
May 23, 2008 (JP) 2008-136070

(51) Int. Cl. H04L 9/32

(52) U.S. Cl. 713/171

(57) ABSTRACT

A key-in processing device for executing a control processing on a basis of information of a key input comprises a determination part for determining what a same key is input continuously, a first storage part for storing information corresponding to an application software that is an object for processing according to the key determined the continuous input, the application software installed on the device, and a notifying part for notifying the application software corresponding to the information stored in the first storage part of information corresponding to the key determined the continuous input.

### CROSS-REFERENCE TO RELATED APPLICATIONS

This application is based upon and claims the benefit of priority of the prior Japanese Patent Application No. 2008-136070, filed on May 23, 2008, the entire contents of which are incorporated herein by reference.

### FIELD

The embodiments discussed herein are related to a key-in processing device and a key-in processing method.

### BACKGROUND

In a mobile phone or a personal computer (hereinafter, referred to as a key-in processing device occasionally) provided with a key-in unit, information input by depressing a key is used to control processing of application software operating on the device.

A user of a key-in processing device depresses a key in accordance with the status of application software which is being currently used to control the application software.

For example, in the case that a mobile phone is being used as a music player, a user of the mobile phone depresses an on-hook key, the on-hook key combining with an end key, of the mobile phone so as to terminate use of the mobile phone as the music player.

However, in the case that a call is received by the mobile phone when the user has continuously depressed the on-hook key in order to terminate the use of the mobile phone as the music player, it may sometimes occur that the incoming call received is terminated by continuously depressing the on-hook key simultaneously with termination of the use of the mobile phone as the music player.

As for a personal computer, in a situation where a plurality of pieces of application software are operating and being displayed on the computer's monitor at the same time, it may sometimes occur that information input through the keyboard of the computer is input into an unintended piece of application software by a user.

Likewise, even in the case that a button on a Web browser is depressed and a program corresponding to the button is being executed, it may sometimes occur that processing of the program is suspended due to depression of this button or another button. Thus, as for a specific button, there has been studied a method of preventing another button from being depressed until execution of processing which is to be executed when the specific button has been depressed is completed, for example, as disclosed in Japanese Laid-Open Patent Publication No. 2000-207092.

As described above, it may sometimes occur that the function of a key which has been continuously depressed by a user of a mobile phone or a personal computer is executed for unintended application software.

### SUMMARY

According to an aspect of an embodiment, a key-in processing device for executing a control processing on a basis of information of a key input, the key-in device comprises a determination part for determining what a same key is input continuously, a first storage part for storing information corresponding to an application software that is an object for processing according to the key determined the continuous input, the application software installed on the device, and a notifying part for notifying the application software corresponding to the information stored in the first storage part of information corresponding to the key determined the continuous input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 shows a structure of a mobile phone;

FIG. 2 is a diagram illustrating key information processing executed by the mobile phone shown in FIG. 1;

FIG. 3 is a flowchart illustrating key information processing;

FIG. 4 is a diagram illustrating continuous event processing;

FIG. 5 shows a structure of a personal computer; and

FIG. 6 is a diagram illustrating key information processing executed by the personal computer shown in FIG. 5.

### DESCRIPTION OF EMBODIMENTS

Next, preferred embodiments will be described with reference to the accompanying drawings. Note that in the drawings, the same or like parts are designated by the same numerals.

Although a mobile phone will be described as an example of a key-in processing device, a device in which processing is controlled by key-in (depression of a key or a button) such as a personal computer may be also given as an example of the key-in processing device.

### First Embodiment

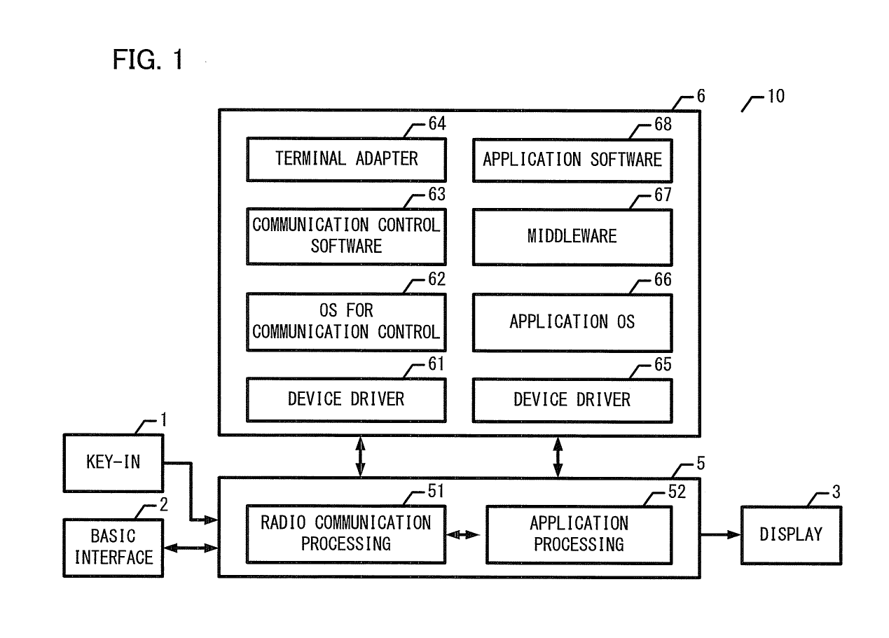

FIG. 1 is a diagram showing a structure of a mobile phone.

A mobile phone 10 includes constitutional elements 1, 2, 3, 5 and 6, which will be described hereinbelow.

A key-in unit 1 generates information (key information) used to identify a key depressed in accordance with a key (a button in some cases) installed on the mobile phone 10. The key-in unit 1 includes, for example, an off-hook key, an on-hook key, numeral keys from “0” to “9”, a clear key, a menu key, a decision key and a cursor key.

A basic interface unit 2 includes an antenna, a microphone and a loudspeaker, and processes signals required for radio communication processing which is a basic function of the mobile phone 10.

A display unit 3 displays characters/letters and figures with which the mobile phone 10 notifies its user of a situation of processing and makes the user confirm the situation.

A control processing unit 5 includes a radio communication processing section 51 and an application processing section 52 to process and control the key information from the key-in unit 1, information on radio communication with the basic interface unit 2 and information on display on the display unit 3.

The radio communication processing section 51 has a CPU (Central Processing Unit) for processing communication and call processing controlling to provide a layer 1 function for performing the communication and call processing.

The application processing section 52 has a CPU taking charge of application processing to perform processing of the key information from the key-in unit 1, processing of information displayed on the display unit 3 and processing for operating application software installed on the mobile phone 10.

The radio communication processing section 51 and the application processing section 52 also perform processing of information required for signal transmission/reception from a radio communication function to an application function and vice versa. For example, the application processing section 52 notifies the radio communication processing section 51 of numeral key information used to designate a destination and the radio communication processing section 51 notifies the application processing section 52 of communication status information used to display a status of communication which is currently in progress.

A software group 6 includes pieces of software 61 to 68 which will be described hereinbelow.

A device driver 61 is software used to make use of peripheral devices required to execute mobile communication processing which is a basic function of the mobile phone 10. An OS for communication control 62 is an OS (Operating System) prepared for a CPU for communication control incorporated into the radio communication processing section 51. Communication control software 63 is software used to perform processing of a communication control (layer 2/layer 3 control) protocol. A terminal adapter 64 is software used to process an interface signal used to connect the device to a DSU (Digital Service Unit) over ISDN (Integrated Services Digital Network).

A device driver 65 is software used to make use of peripheral devices required for execution of application functions installed on the mobile phone 10. An application OS 66 is an OS prepared for a CPU for application processing incorporated into the application processing section 52. Middleware 67 is software located in the middle of an OS and application software, such that application software can be run without being affected by the differences of the hardware or the OS. Application software 68 is application software installed on the mobile phone 10 and includes, for example, software used to process key information which has been key-input, mail software used to implement an electronic mail, software used to implement a music player and game software used to implement an electronic game.

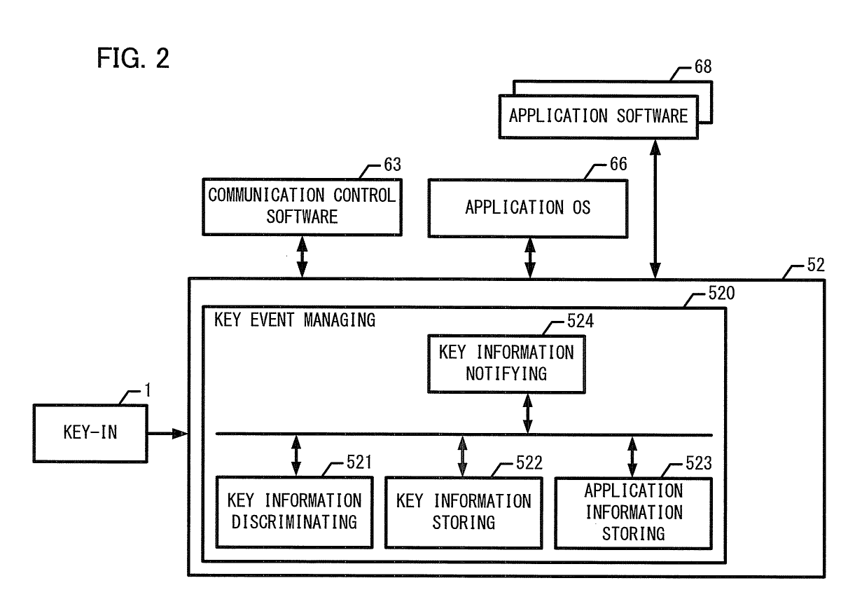

FIG. 2 is a diagram illustrating key information processing executed by the mobile phone shown in FIG. 1. The application processing section 52 shown in FIG. 1 has a key event managing part 520. The key event managing part 520 has a key information discriminating portion 521, a key information storing portion 522, an application information storing portion 523 and a key information notifying portion 524.

Information corresponding to a key, in other words information for identifying the kind of the key (key information) which has been input using the key-in unit 1 is input into the key event managing part 520. Then, the key event managing part 520 stores the key information in the key information storing portion 522, together with information on a time (time information) at which that key has been input.

The key event managing part 520 notifies the key information discriminating portion 521 of previously notified key information and time information thereof which have been read out from the key information storing portion 522 and key information and the time information thereof which have been notified in order to be stored in the key information storing portion 522.

The key information discriminating portion 521 confirms that two pieces of notified key information are the same as each other, determines whether the key has been input at input intervals smaller than a predetermined interval from the previous time information which has been notified and the time information which has been notified to the key information storing portion 522 to be stored therein and notifies the key event managing part 520 of a result of the determination. Hereinafter, an event where the key has been input at intervals smaller than the predetermined interval will be referred to as a “continuous event”.

Incidentally, the predetermined interval may be set by a user of the mobile phone 10.

In the case that the key information notified to the key event managing part 520 from the key information discriminating portion 521 is a key information relating to radio communication processing or a key information which has been input during execution of communication processing, the key event managing part 520 notifies the communication control software 63 of the key information via the key information notifying portion 524.

On the other hand, in the case that the notified key information doesn't relate to mobile communication processing and is not of a continuous event (that is, a single event), the key event managing part 520 stores information on application software to be processed in accordance with the notified key information, for example, an identifier with which the application software 68 can be specified in the application information storing portion 523 on the basis of information had on the application OS 66 and notifies the application software 68 to be processed in accordance with the key information, of the key information. In the case that the key information notified to the key event managing part 520 from the key information discriminating portion 521 is of a continuous event, the key event managing part 520 notifies the application software 68 to be processed in accordance with the notified key information, of the notified key information, on the basis of the information of application software which has been stored in the application information storing portion 523 in the case that the key information was of a single event.

Incidentally, the application OS 66 operates to manage the application software 68 installed on the mobile phone 10, to recognize the application software 68 operating on the mobile phone 10 and to also recognize the order of priority in which the application software 68 is processed. For examples, in the mobile phone 10, the orders of priority in which software used to receive disaster information or warning notification and software used to receive notification of safety confirmation are processed are higher than those of other pieces of application software. Thus, even though a plurality of pieces of application software are being run, the application OS 66 operates to display application software of the highest priority order among the plurality of pieces of software on the front frame displayed on the display unit 3.

The above mentioned continuous event is supposed to be used as a result of determination of continuous operation of the same key, such as an on-hook key or a clear key in the case that a mobile phone is given as an example.

According to the above mentioned key information processing, the key event managing part 520 determines whether the key information input by the user is of a continuous event. In the case that the key information is determined to be of a continuous event, it becomes possible to accurately notify application software to be processed in accordance with this key information, of this key information and hence it becomes possible to prevent the key information from being notified to unintended application software.

As an alternative, when information on application software to be processed in accordance with key information is to be stored in the application information storing portion 523, the key event managing part 520 may notify the application software 68 concerned of the key information, may receive a response signal indicative of normal reception of the key information from the application software 68 and may store information on the application software 68 in the application information storing portion 523.

That is, in the case that the key information notified to the key event managing part 520 from the key information discriminating portion 521 is not of a continuous event, the key event managing part 520 notifies the application software 68 to be processed in accordance with the key information notified, of the key information notified, on the basis of the information had on the application OS 66. In the case that the key information notified has been normally received by the application software 68 which has received the notification of the key information, the software 68 operates to return a response to the key event managing part 520. In the case that a response signal indicative of normal reception of the key information has been received, the key event managing part 520 stores information on this application software, that is, an identifier with which, for example, the application software 68 can be specified in the application information storing portion 523. In the case that the key information notified from the key information discriminating portion 521 was of a continuous event, the key event managing part 520 notifies the application software 68 to be processed in accordance with the key information notified, of the key information notified, on the basis of information on application software stored in the application information storing portion 523.

As mentioned above, in the case that information on application software to which key information is to be notified is to be stored, the information is stored on the basis of a response signal from the application software. Therefore, the information on the application software to which the key information has been surely notified can be stored.

Incidentally, as the key information storing portion 522 and the application information storing portion 523, storage media (not shown) such as memories incorporated into the application processing section 52 may be used.

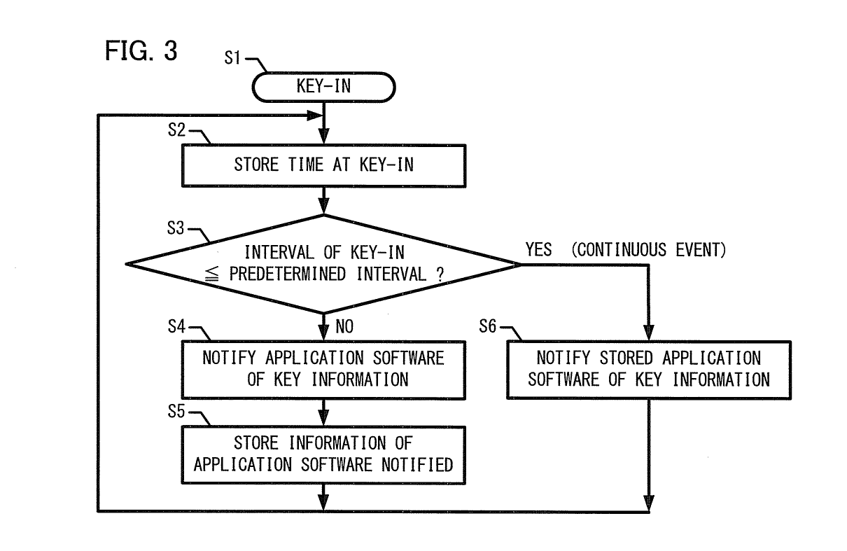

FIG. 3 is a flowchart illustrating key information processing. The case where the user of the mobile phone 10 uses an application function to perform key-in for application software of the mobile phone 10 will be described.

S1. The user performs key-in.

S2. The key event processing part 520 stores information on a time at which the key-in occurred in the key information storing portion 522, together with information corresponding to an input key (key information).

S3. The key event managing part 520 reads out previously notified key information and time information from the key information storing portion 522 and notifies the key information discriminating portion 521 of the key information and the time information so read out, together with the key information and the time information which have been notified to be stored in the key information storing portion 522 at step S2. The key information discriminating portion 521 confirms that these two pieces of key information so notified are the same as each other and determines whether the key-in is of a continuous event in which the key has been input at input intervals smaller than a predetermined interval from the previous time information notified and the time information which has been notified to the key information storing portion 522. In the case that the key-in is determined to be of a continuous event, processing at step S6 is executed. On the other hand, in the case that the key-in is not of a continuous event, that is, the key-in is of a single key-in or the first key-in in a continuous event, processing at step S4 is executed.

S4. In the case that it is determined that the key-in is not of a continuous event at step 3, the key event managing part 520 notifies the application software 68 to be processed in accordance with the key information notified from the key information discriminating portion 521, of the key information notified.

Incidentally, the application OS 66 operates to recognize the application software to be processed in accordance with the key information notified, so that the application software can be found on the basis of information from the application OS 66. That is, the application OS 66 operates to manage respective pieces of application software and their priority orders, so that information on application software of the highest priority order among a plurality of pieces of application software which are being currently used can be found from the information had on the application OS 66.

S5. The key event managing part 520 stores information on application software to which the key information has been notified, such as an identifier with which, for example, the application software 68 can be specified in the application information storing portion 523.

S6. In the case that the key-in is determined to be of a continuous event at step S3, the key event managing part 520 notifies the application software 68 of the key information on the basis of application information stored in the application information storing portion 523.

Incidentally, the continuous event determined at step S3 is supposed to be used as a result of determination as to continuous operation of the same key such as an on-hook key or a clear key in the case that a mobile phone is used.

As an alternative, in the case that the normal response has been obtained from the application software to which the key information has been notified at step S4, the key event managing part 520 may prepare procedures for storing information on the application software in the application information storing portion 523 at step S5.

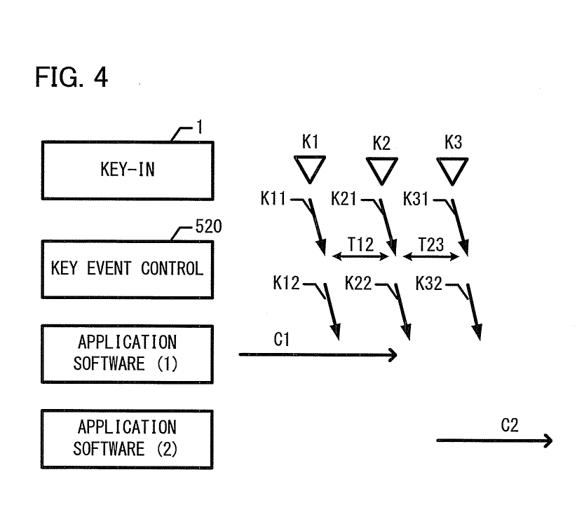

FIG. 4 is a diagram illustrating continuous event processing. FIG. 4 shows a flow of notifying application software of key information, in time series in a horizontal direction of the drawing, in the case that a continuous event has occurred by key-in.

In the key-in unit 1, for example, it is supposed that the user of the mobile phone 10 has continuously depressed the on-hook key as shown by K1, K2 and K3. Intervals between depressions K1 and K2 and depressions K2 and K3 are T12 and T23, respectively. These intervals are smaller than a predetermined interval and hence this key-in is determined to be of a continuous event.

With the depression K1 of the on-hook key, key information K11 is notified from the key-in unit 1 to the key event managing part 520. Likewise, with the depressions K2 and K3 of the on-hook key, two pieces of key information K21 and K31 are notified from the key-in unit 1 to the key event managing part 520. These pieces of key information are determined to be key information not relating to radio communication processing.

The key event managing part 520 notifies application software (1) to be processed in accordance with the key information K11, of key information K12 (on-hook key information).

Since the depressions K2 and K3 of the on-hook key have been determined to be of a continuous event, the key event managing part 520 notifies the application software (1) of key information K22 and K32.

As shown by C1 in FIG. 4, execution of the application software (1) terminates with the key information K12 (the on-hook key information).

As shown by C2 in FIG. 4, it is supposed that application software (2) is run between the key depressions K2 and K3. Then, for example, regardless of the fact that an electronic mail has been received at this timing and the on-hook key depression K3 has occurred after running of electronic mail software, key information K32 generated with the on-hook key depression K3 is notified to the application software (1) and is not notified to the application software (2) (the electronic mail software).

According to the above mentioned embodiment, in the case that a key has been input at intervals smaller than a predetermined interval, this key-in is determined to be of a continuous event and information corresponding to the key can be notified only to application software to be processed in accordance with the key information. Therefore, even if different application software is run in the midst of a continuous event, improper processing in which the key information for a continuous event is notified to the different application software can be avoided.

### Second Embodiment

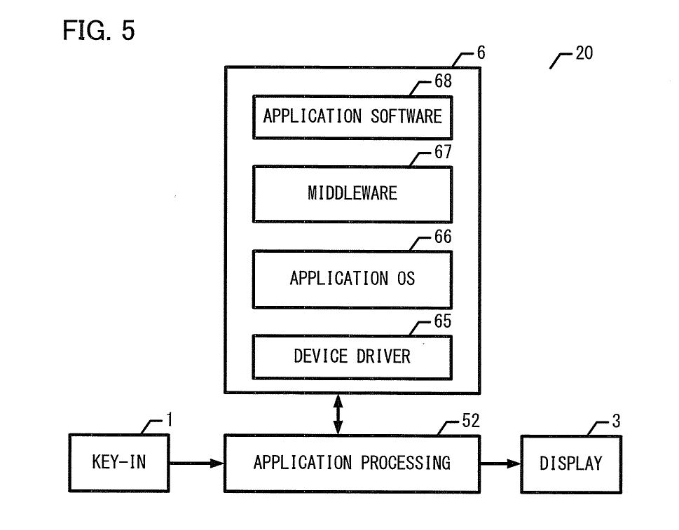

FIG. 5 is a diagram showing a structure of a personal computer, corresponding to FIG. 1 showing a structure of the mobile phone 10.

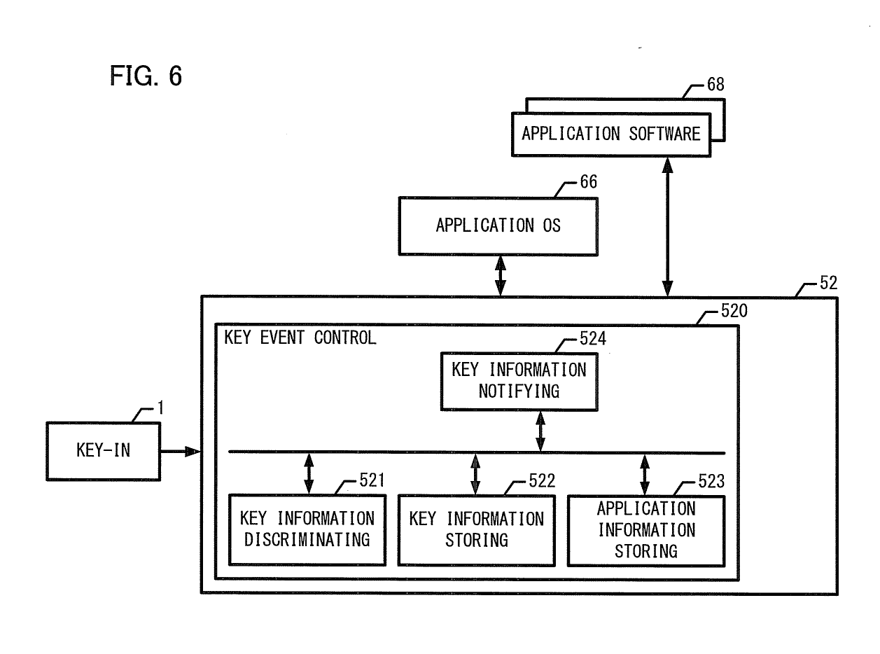

FIG. 6 is a diagram illustrating key information processing executed by the personal computer shown in FIG. 5, corresponding to FIG. 2 showing key information processing executed by the mobile phone shown in FIG. 1.

As shown in FIGS. 5 and 6, only the communication function for mobile communication installed on the mobile phone 10 in the first embodiment is not installed on a personal computer 20, so that the contents described in relation to the first embodiment can be embodied also in the personal computer 20.

Thus, the same effects as those attained by the first embodiment can be also attained by the personal computer 20.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. A key-in processing device for executing a control processing on a basis of information of a key input, the key-in device comprising:
a determination part for determining what a same key is input continuously;
a first storage part for storing information corresponding to an application software that is an object for processing according to the key determined the continuous input, the application software installed on the device; and
a notifying part for notifying the application software corresponding to the information stored in the first storage part of information corresponding to the key determined the continuous input.

2. The key-in processing device according to claim 1, further comprising:
a second storage part for storing information corresponding to an application software having a highest processing priority, the application software being in operation on the device.

3. The key-in processing device according to claim 1, wherein the first storage part stores the information corresponding to the application software on a basis of a response signal from the application software notified of the information corresponding to the input key.

4. The key-in processing device according to claim 1, wherein the determination part determines continuity of the key input on a basis of an input interval of the same key.

5. The key-in processing device according to claim 1, wherein the key-in processing device is a mobile phone and the key input continuously is an end key.

6. A key-in processing method of preventing an improper processing caused by a key input continuously, the key input processing method comprising:
a determination step of determining continuity of a key input on a basis of an input interval of a same key;
a storage step of storing information corresponding to an application software notified of information corresponding to the key input in case of the key input interval being smaller than a predetermined interval; and
a notifying step of notifying the application software corresponding to the information stored on a basis of the key input of the information corresponding to the key determined the continuous input.

7. The key-in processing method according to claim 6, wherein the storage step stores the information corresponding to the application software on a basis of a response signal from the application software notified of the information corresponding to the input key.

8. The key-in processing method according to claim 6, wherein the notifying step notifies the application software having a highest processing priority of the information corresponding to the key input continuously, the application software being in operation.
